(19) United States
(12) Patent Application Publication
(10) Pub. No.: US 2015/0376001 A1
(43) Pub. Date: Dec. 31, 2015

(54) METHOD FOR THERMAL DECOMPOSITION BY PYROLYSIS IN A MOVING BED REACTER

(71) Applicant: ECOLOOP GMBH, Goslar (DE)

(72) Inventors: Thomas STUMPF, Bad Harzburg (DE); Leonhard BAUMANN, Aldersbach (DE); Roland MOLLER, Bad Harzburg (DE); Gunter ULBRICH, Obhausen (DE); Thomas VON BEOECZY, Langelsheim (DE)

(21) Appl. No.: 14/850,343

(22) Filed: Sep. 10, 2015

Related U.S. Application Data
(62) Division of application No. 14/005,702, filed on Sep. 17, 2013.

(30) Foreign Application Priority Data
Mar. 18, 2011 (DE) 10 2011 014 349.1

(51) Int. Cl. C01B 3/02

(52) U.S. Cl. CPC C01B 3/02

(57) ABSTRACT

A method for thermal decomposition of carbon-rich substances. Pyrolysis is used to transform substances into a synthetic gas. Bulk material including carbon enriched substances flows vertically in succession through an upper column, a moving bed reactor having an upper hollow chamber in the top thereof, a lower hollow chamber and a lower column, wherein the bulk material from the moving bed reactor is removed through the lower column. Pyrolysis is performed in the moving bed reactor and the synthetic gas is collected in the upper hollow chamber. The width and height of the upper and lower columns and the nature of the bulk material have an internal pressure loss which seals off the movable bed reactor and enables a continuous or batch-wise flow of bulk material. The pressure difference between the lower hollow chamber and the upper hollow chamber is at least 50 mbar. The pressure difference is stabilized by the bulk material inside the moving bed reactor.

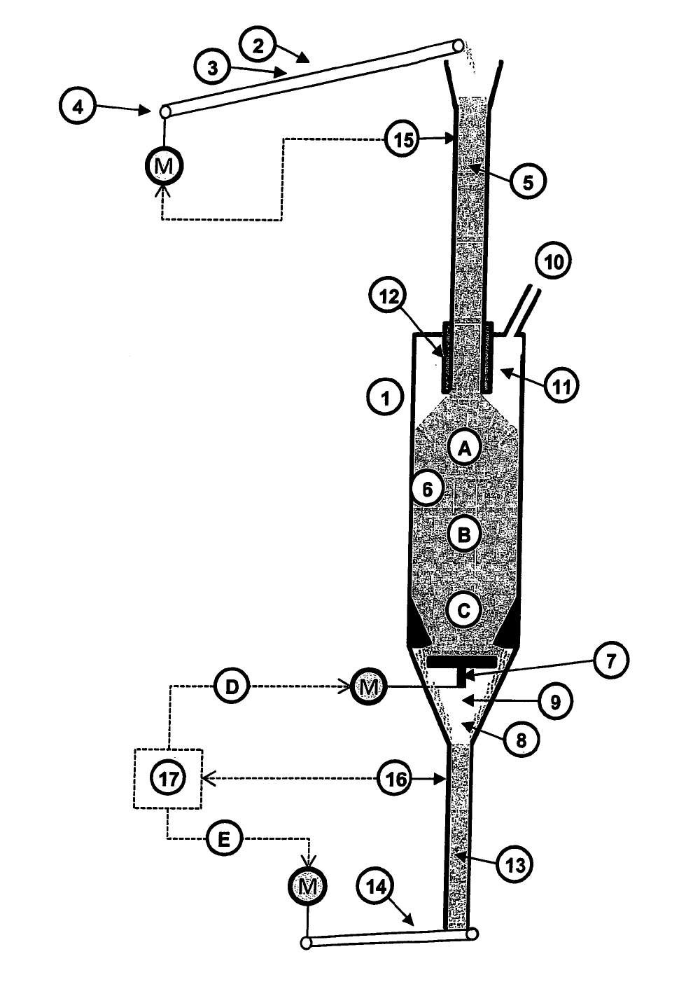

This application is a Divisional Application of application Ser. No. 14/005,702, filed Sep. 17, 2013, now pending (which is hereby incorporated by reference)

The present invention relates to for thermal decomposition by pyrolysis of carbon-rich substances in a moving bed reactor through which a bulk material flows from top to bottom, in which a vertical bulk material column is provided for the delivery of material flows. One such apparatus is known from DE 10 2007 062 414 A1, for example. In operating such an apparatus, difficulties can arise if certain pressure conditions have to be established in the interior of the reactor, in order on the one hand to effect stable chemical reactions and on the other perhaps to promote the countercurrent of gases in the reactor.

The thermal exploitation of carbon-rich substances, and in particular the gasification of waste that contains plastic, or of contaminated carbon carriers or even biomasses has been of great interest for many years. In the past, major efforts have been made, especially for implementing the gasification of waste containing plastics. Numerous methods were carried on a large industrial scale, and various types of reactors were used, such as rotary drum reactors, fluidized bed reactors, or even moving bed reactors.

The known apparatuses and methods had considerable disadvantages, which in almost all cases led to shutting these large-scale projects down again. In particular, there were problems in the area of delivering plastic to the reactor and in removing the residues. The flow through the reactor and maintaining a continuous countercurrent of a gaseous medium were problematic as well.

For the delivery and removal of the starting substances and the residues, complicated worm, sluice, or even ram-type devices were used, which typically have complex structural features, such as rotating parts, flap mechanisms, and static or dynamic sealing systems. Particularly when low-melting materials such as plastics were used, massive problems arose in these devices because of deposits of molten material, baked-on deposits, and clogging. This causes down times in the system, since the delivery and removal devices have to be cleaned frequently, or there were leaks from the reactor interior. The attendant fluctuations in the pressure conditions or even the emission of undefined gas mixtures are especially disadvantageous.

The object of the present invention is to provide an improved method of the type described at the outset in such a way that safer operation is possible, with a reliably sealed reactor interior and with the establishment of preferred pressure conditions.

According to the invention, this object is attained in that for removing material flows, a vertical bulk material column is provided, and the widths and heights of the bulk material columns and the nature of the bulk material are selected such that the bulk material columns on the one hand via their internal pressure loss effect sealing off of the reactor interior from the atmosphere, and on the other hand they enable a continuous or batchwise bulk material flow, and in the upper reactor region a first hollow chamber and in the lower reactor region a second hollow chamber are provided, between which a pressure difference Δp of at least 50 mbar is provided, which is stabilized by the pressure loss via the bulk material inside the moving bed reactor.

It has been demonstrated that with such an arrangement, carbon-rich substances can be thermally exploited; the system has high availability, and fixtures that are likely to malfunction can be dispensed with the delivery and removal areas. The system is especially suited to the production of synthetic gas, which can be collected in the upper hollow chamber of the reactor and removed by suitable devices.

The vertical bulk material columns, together with the vertical moving bed, allow bulk material motion based solely on the force of gravity on the bulk material itself, without having to provide moving elements to ensure the flow of bulk material.

Preferably, the vertical bulk material column for delivering the material flows is connected in communicating fashion with the bulk material of the moving bed reactor. This embodiment is especially preferred with continuous material flows, since because of the bulk material advancement without drop sections in the reactors, discontinuous courses of motion are avoided.

A further preferred embodiment of the invention the vertical bulk material column for removing the material flows is separated by the hollow chamber embodied in the lower part of the reactor from the bulk material of the moving bed of the moving bed reactor itself.

The forming of the hollow chamber in the lower part of the reactor can be effected for instance by means of a bulk material metering device, which continuously or in batches meters the bulk material from the moving bed reactor into the hollow chamber that is formed. As the bulk material metering devices, rotary-table or slider-table apparatuses, known for instance from calcining shaft furnace construction, can be used, for example.

In a further preferred embodiment of the invention, it is provided that the bulk material below the hollow chamber in the lower part of the reactor is connected in communicating fashion with the vertical bulk material column for removing the material flows.

In an even more strongly preferred embodiment, it is provided that above the entry of the bulk material into the vertical bulk material column for the delivery of the material flows, a mixing device is provided, which mixes the bulk material with the carbon-rich substances, so that it serves as a transporting medium for the carbon-rich substances into the moving bed reactor. In this way, by purposeful adjustment of the proportion of carbon, under favorable conditions the reactor can be operated even without having to supply additional fuel.

In an especially preferred embodiment of the invention, a cooling device is provided, which with a cooling medium completely or partially indirectly cools a tubular jacket of the vertical bulk material column for the delivery. In the simplest case, this cooling medium can be water, and embodiments in which the water is not circulated in a closed cycle but then flows into the reactor interior are also conceiveable.

Cooling the tubular jacket prevents plastics, which easily melt because of the higher temperatures that may prevail in this region, from baking into clumps in the bulk material column.

The tubular jacket of the vertical bulk material column for the delivery can also plunge all the way or partway into the upper part of the moving bed of the reactor and as a result can form the upper hollow chamber in the upper part of the moving bed reactor.

The mean operating pressure in the moving bed reactor is preferably below 3 bar (ü), preferably below 1 bar (ü), and especially preferably in a range below 0.1 bar (ü).

One example for the geometry of the bulk material columns, which has proved effective in operation, provides that the vertical bulk material column for the delivery has a quotient formed from the bulk material height (in meters) divided by the maximum pressure difference between the operating pressure (in bar) in the reactor head and the prevailing atmospheric pressure (in bar) of >10, and the vertical bulk material column for the removal has a quotient formed from its bulk material height (in meters) divided by the maximum pressure difference between the operating pressure (in bar) at the reactor bottom and the prevailing atmospheric pressure (in bar) of >5. The different quotients are due to the fact that the nature of the bulk material varies because of the oxidized carbon ingredients.

The established pressure difference of at least 50 mbar mentioned at the outset is preferably below 1 bar, since as a rule, for the sake of a safe course of operation, higher pressure differences are inappropriate.

Advantageously, work is done with bulk materials of calcium oxide, calcium carbonate, and/or calcium hydroxide as ingredients, especially since with halogen-containing plastics they have the favorable properties of binding the halogens and removing them from the process. The catalytic action of the calcium compounds, especially calcium oxide in thermal decomposition, is particularly advantageous. The method can be coupled with the production of quicklime, so that the apparatus can be operated economically.

With regard to the pyrolysis operation itself, it has proved advantageous if the total λ (i.e., the ratio of actual air to fuel ratio to the stoichiometric air fuel ratio) of the oxidation process in the moving bed reactor through all the stages is less than 0.5. Overall, the oxidation is thus done with oxygen deficiency, and the λ value can be reduced still further, and good results have been obtained in a region with a λ of 0.3.

One embodiment of the present invention is shown in the accompanying drawing. The embodiment shows a calcining shaft furnace, of the kind used on a large industrial scale, for example in burning or sintering processes, in a modified form that is used as a moving bed reactor 1. The moving bed reactor 1 is continuously charged with a mixture of carbon-rich substances 2 and refractory bulk material 3. The charging is done via a conveyor device 4 and a vertical bulk material column 5, whose ctg is connected in communicating fashion with the bulk material 6 in the moving bed reactor. The flow of the bulk material 6 in the moving bed reactor 1 is effected by the action of gravity from top to bottom, in that the bulk material metering device 7 continuously, or in batches, feeds the bed from the moving bed reactor 1 into a hollow chamber 8, which is located at the lower end of the moving bed reactor 1. As a result of this withdrawal, the bulk material slides continuously downward, and as a result, mixtures of carbon-rich substances 2 and refractory bulk material 3 can also slide along the bulk material column 5 into the moving bed reactor.

The moving bed reactor is operated as a so-called countercurrent gasifier, in which oxygen-containing gas 9 is fed in at the bottom of the reactor. Because of the gasification process, at least the following three processes develop: in the upper part of the bulk material 6, a pyrolysis zone A in which the carbon-containing substances already partially react or change into coke, in the further course downward, a hotter burning zone B in which the remaining carbon compounds are converted into synthetic gases, and in the lower part a cooling zone C. The synthetic gas occurring in process zones A and B leaves the moving bed reactor at the head, at 10.

The bulk material column for delivering bulk material is in this example embodied as a plunger tube, which plunges into the upper part of the moving bed reactor. The height of the bulk material 6 in the reactor and especially the volume of the resultant gas chamber 11 can both be purposefully varied by way of the choice of the depth to which the plunger tube plunges.

Since in the gas chamber 11 in the upper region of the reactor, temperatures of over 300° C. can develop, in the exemplary embodiment shown, the area of the tubular jacket of the bulk material column 5 that has plunged into the reactor is cooled by water, by means of a double wall 12 or a coiling coil system. This makes it possible for even carbon-rich substances, such as plastics, that melt at low temperatures to be unproblematically processed in the system, without the possibility of clumping. The use of complicated fixtures or sluice systems for the delivery to the moving bed reactor 1 can be dispensed with.

In the hollow chamber 8, the mixture of refractory bulk material 3 and thermally unusable residues, such as ashes, is connected in communicating fashion to the bulk material column 13 for the removal of the material from the reactor system.

The bulk material column 13 communicates at its lower outlet directly with a removal conveyor 14, which comprises a vibration trough or a discharging belt. With this removal conveyor 14, the bulk material column 13 is discharged from the reactor system, continuously or in batches.

The control of the reactor is done by means of the throughput of oxidizable mixture and the proportion of carbon-rich substances. This control can be done on the one hand in the vicinity of the mixing device 4, but on the other even solely by the throughput of the metering device 7 above the hollow chamber 8, which device controls the throughput speed of the bulk material in the reactor. To enable safe operation of the process of thermal exploitation, safe sealing of the reactor interior from the atmosphere must also be ensured at all times. This is necessary first to prevent the escape of synthetic gas but also, in the event of underpressure, to preclude the penetration of oxygen from the air and the development of an explosive mixture in the reactor interior. This sealing is done via the pressure loss of the two bulk material columns for the delivery and the removal. It must therefore be ensured that both bulk material columns have a minimum fill height at all times and in every operating condition. The bulk material column 5 for delivering the material is therefore equipped with a fill level gauge 14, which acts as an actuating variable on the rotary speed of the conveyor device 4 for the delivery of material into the bulk material column 5 and always ensures a minimum fill level.

Ensuring a minimum fill level in the bulk material column 13 for removing the material is also done via a fill level gauge 16. Via a regulator 17, it can act selectively as an actuating variable D on the discharge speed of the metering device 7, or alternatively as an actuating variable E on the rotary speed of the removal conveyor 14. The separate control circuits for the bulk material columns ensure that even in the event of instabilities in the bulk material flow inside the reactor, a sufficient bulk material column height in both delivery and removal is always maintained.

1. A method for thermal decomposition of carbon-rich substances by pyrolysis to transform the substances into synthesis gas, comprising the steps of:
flowing a bulk material comprising a mixture of bulk material which includes carbon-rich substances vertically, in succession, through an upper column, a moving bed reactor, a lower hollow chamber and a lower column, and removing the bulk material from the moving bed reactor through the lower column,
the moving bed reactor having an upper hollow chamber in the upper region thereof, the pyrolysis taking place in the moving bed reactor and the synthesis gas collecting in the upper hollow chamber,
the width and height of the upper and lower columns and the nature of the bulk material being selected such that (1) their internal pressure loss seals off the movable bed reactor from the atmosphere and (2) a continuous or batch-wise bulk material flow is enabled,
providing a pressure difference between the lower hollow chamber and the upper hollow chamber of at least 50 mbar; and
stabilizing the pressure difference by the bulk material inside of the moving bed reactor.

2. The method of claim 16, including the step of delivering bulk material from the upper column directly into the movable bed reactor.

3. The method of claim 16, wherein the lower column is separated by the lower hollow chamber from the movable bed reactor.

4. The method of claim 18, wherein the size of the lower hollow chamber is dependent upon the amount of bulk material flowing from the movable bed reactor into the lower column, and including the step of metering said flow of bulk material continuously or in batches.

5. The method of claim 19, wherein the step of metering is performed by a rotary-table or slider-table apparatus.

6. The method according to claim 18, wherein the bulk material below the lower hollow chamber flows to the lower column for removal from the moving bed reactor.

7. The method according to claim 16, wherein the step of introducing bulk material into the upper column is carried out by a conveyor which mixes carbon-rich substances into the bulk material.

8. The method according to claim 16, including cooling the upper column with a cooling medium within a cooling jacket surrounding the upper column.

9. The method of claim 16, including varying the location of the tubular jacket to be partially or totally into the movable bed reactor such that the upper hollow chamber is formed in part by the outside of the tubular jacket.

10. The method of claim 16, including maintaining the mean operating pressure in the movable bed reactor below 3 bar.

11. The method of claim 25, wherein the mean operating pressures is below 1 bar.

12. The method of claim 27, wherein the mean operating pressure is below 0.1 bar.

13. The method of claim 16, wherein the upper column has a quotient formed from the bulk material height, in meters, divided by the maximum pressure difference between the operating pressure, in bar, in the reactor head and the prevailing atmospheric pressure, in bar, of >10, and the lower column has a quotient formed from its bulk material height, in meters, divided by the maximum pressure difference between the operating pressure, in bar, at the reactor bottom and the prevailing atmospheric pressure, in bar, of >5.

14. The method of claim 16, wherein the pressure difference is up to a maximum of 1 bar.

15. The method of claim 16, wherein the bulk material contains calcium oxide, calcium carbonate and/or calcium hydroxide.

16. The method of claim 16, wherein the total A of the oxidation process in the moving bed reactor through all stages is less than 0.5.

17. The method of claim 16, including controlling the thermal separating operation by varying the portion of the carbon-rich substances in the remainder of the bulk material.
